(19) United States
(12) Patent Application Publication
(10) Pub. No.: US 2013/0262873 A1
(43) Pub. Date: Oct. 3, 2013

(54) METHOD AND SYSTEM FOR AUTHENTICATING REMOTE USERS

(71) Applicant: CGI FEDERAL INC., Fairfax, VA (US)

(72) Inventors: David McArthur READ, Austin, TX (US); Christopher J. FOLEY, Manassas, VA (US); Terrance E. BOULT, Monument, CO (US); Walter J. SCHEIRER, Colorado Springs, CO (US)

(73) Assignee: CGI FEDERAL INC., Fairfax, VA (US)

(21) Appl. No.: 13/853,783

(22) Filed: Mar. 29, 2013

Related U.S. Application Data
(60) Provisional application No. 61/618,295, filed on Mar. 30, 2012.

(51) Int. Cl. H04L 29/06

(52) U.S. Cl. CPC H04L 63/0861
USPC 713/186

(57) ABSTRACT

A user of a mobile device can be authenticated based on multiple factors including biometric data of the user. During an enrollment process of the user, an encryption key is sent to the mobile device via a message. The encryption key is recovered from the message and used to encrypt communications between the mobile device and a server. Biometric data is collected from the user and sent to the server for computing a biometric model (e.g., a voice model, etc.) of the user for later use in authentication. An encrypted biometric model is stored only in the mobile device and the encrypted biometric model is sent to the server for authentication of the user. For authentication, various information including an identification of the mobile device, responses to challenge questions, biometric data including the biometric model, etc. are used at the server.

### CLAIM OF PRIORITY UNDER 35 U.S.C. §119

This application relates to and claims priority to U.S. provisional application, 61/618,295, titled “METHOD AND SYSTEM FOR AUTHENTICATING REMOTE USERS,” filed Mar. 30, 2012, the entire disclosure of which is incorporated herein by reference.

### BACKGROUND

Biometric authentication may be used to identify and authenticate individuals using their personal traits and characteristics (e.g., voice, hand or finger print, facial features, etc). Typically, such biometric information is collected from individuals and a biometric template is extracted from the collected information. The template is then stored in a central location on a network for use in later verification. However, this collection and storage of biometric information on the network may cause privacy issues since the individuals providing the biometric information may wish to retain control of that information in order to be able to delete it or revoke access to it in the future. In addition, there is a need for more secure methods of authenticating the user using multi-factor authentication techniques that combine multiple types of information to allow higher confidence in the remote user's identity.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a conceptual high-level diagram of the factors that may be used by certain embodiments disclosed herein to authenticate a user.

FIG. 2A is a high-level perspective view of an embodiment of the present disclosure.

FIG. 2B is a high level diagram of some of the services that may be offered by the exemplary Secure Authentication for Mobile Enterprises (SAME) Service.

FIGS. 2C-2G illustrate high level diagrams of some of the services that may be included in the SAME Service.

FIG. 3 is a high level block diagram illustrating an exemplary sequence of the disclosed techniques herein.

FIG. 4 is a high level block diagram illustrating an exemplary sequence of the disclosed techniques.

FIGS. 5A-5B illustrate high level exemplary displays on the mobile device for enrolling a user of the mobile device for voice biometric based authentication.

FIG. 6 illustrates high level exemplary displays on the mobile device for signing in to the secure server using voice biometric of the user after the enrollment process of the user has been completed in FIGS. 5A and 5B.

FIG. 7 shows another illustration of an exemplary process of authenticating a user using voice biometric data.

FIG. 8 is a high-level block diagram further illustrating an exemplary implementation of the SAME Service on a network or server side implementation for biometric based authentication.

FIGS. 9 and 10 are flow diagrams of exemplary embodiments of the SAME Service.

FIGS. 11 and 12 provide functional block diagram illustrations of general purpose computer hardware platforms.

### DETAILED DESCRIPTION OF A PREFERRED EMBODIMENT

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The advantages and novel features are set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations described herein.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

Certain embodiments of the disclosed subject matter relate to authentication of a communications device user based on various factors, such as knowledge (e.g., knowledge of a preset password or pin), possession (e.g., possession of a previously verified communications device, mobile phone, computer, etc.), biometric data (e.g., voice, facial features, facial photos, etc.), and location (from a GPS signal or other location-estimating techniques). In some embodiments, a plurality of biometric data may be acquired and verified and used in authentication of a mobile device user.

In one embodiment, a method for authenticating a user of a mobile device based on multiple factors including a biometric of the user is provided. On the mobile device, a first user input is received for enrolling the user of the mobile device in a multi-factor authentication service for a service provided by an entity over a network. The enrollment information can include data about the mobile device and the user, such as an identification of the mobile device, user account and associated password, which is sent over the network to a server. The enrollment information generally means user information including user's account information, password, and user's biometric information that are needed for enrolling or registering the user for receiving a multi-factor biometric based authentication service. The mobile device receives instructions, via a message, relating to enrolling the user of the mobile device in the multi-factor authentication service from the server. The message includes a quick response (QR) code in which an encryption key is encoded. The mobile device reads the QR code to extract the encryption key to encrypt data between the mobile device and the server. A first list of words is received from the network and presented to the user of the mobile device for obtaining voice samples of the words spoken by the user. The voice samples of the words spoken by the user are obtained and encrypted using the encryption key. The encrypted voice samples are sent to a server on the network for computing a voice model of the user based on the voice samples. The voice model of the user is received from the server on the network and stored in the mobile device for later use in authenticating the user.

In certain embodiments, users may enroll their biometric data with an authentication authority (e.g., an authenticator device, a computer, or a mobile communications service provider) for use in later authentication. The enrolled information may be used to extract a biometric template and the template may be forwarded back to the enrolled user (or the enrolled user's device) for storage.

Further, in order to prevent tampering, in some embodiments, the extracted biometric template may be encrypted and a secure hash value may be computed. The secure hash value is stored with the authentication authority for use in later authentication of the user. The encrypted biometric template is forwarded back to the user/user device for storage. The encrypted biometric template may be transferred back and forth between the user and the authentication server during verification.

In certain embodiments, user authentication may be performed by collecting new biometric information and forwarding the newly collected information along with the previously extracted biometric template that was stored with the user, to the authentication authority. After verifying the secure hash value, the authentication authority may compare the newly collected information to the previously extracted template and generate a match score. The result of the match score may be combined with scores from various other factors (e.g., knowledge, possession, location, etc.) to authenticate the user. Further, in some embodiments, an “out of band” identity verification mechanism may be supported in order to validate user identity before enrollment. In context of authentication, “out-of-band” refers to using a separate network or channel in addition to a primary network or channel for simultaneous communications between two parties or devices for identifying a user. The out-of-band identity verification allows the authentication authority to gain confidence in the user's identity before enrolling the user, thereby preventing nefarious actors from enrolling themselves while impersonating the user. For example, a user may try to log in to a bank's web site, but the bank request additional verification of the user's identity by sending the user's personal identification number (PIN) by short messaging service (SMS) so that the user can enter the PIN on the web login page of the web site. Using the SMS for additional verification in this case, is an example of out-of-band authentication mechanisms.

In certain embodiments, a system includes a mobile device and a biometric authentication server. The mobile device is configured to receive a first user input for enrolling a user of a mobile device in a biometric authentication service for a service provided by an entity over a network. The mobile device is configured to send over the network to the biometric authentication sever enrollment information including an identification of the mobile device, user account, and associated account password. Instructions relating to enrolling the user of the mobile device in the biometric authentication service are received by the mobile device from the biometric authentication service. The mobile device is configured to read a quick response (QR) code including an encryption key for encrypting data communications from the mobile device to the biometric authentication server. The encryption key is extracted from the QR code and a first list of words is received from the network by the mobile device. The first list of words is presented to the user of the mobile device for acquiring voice samples of the words spoken by the user. The mobile device is configured to acquire the voice samples of the words spoken by the user, encrypt the acquired voice samples using the encryption key, and send the encrypted voice samples to the biometric authentication server. The mobile device is configured to receive a voice model from the biometric authentication server, wherein the voice model is generated based on the voice samples. The biometric authentication server is configured to receive from the mobile device enrollment information including the identification of the mobile device, user account and associated account password. The biometric authentication server is configured to send instructions to the mobile device relating to enrolling the user of the mobile device in the biometric authentication service, send to the mobile device over the network the QR code including the encryption key for use by the mobile device, and send to the mobile device over the network the first list of words for the user of the mobile device. The biometric authentication server is further configured to receive from the mobile device over the network the acquired voice samples, generate the voice model of the user based on the received voice samples, and send the generated voice model to the mobile device for storage in the memory of the mobile device.

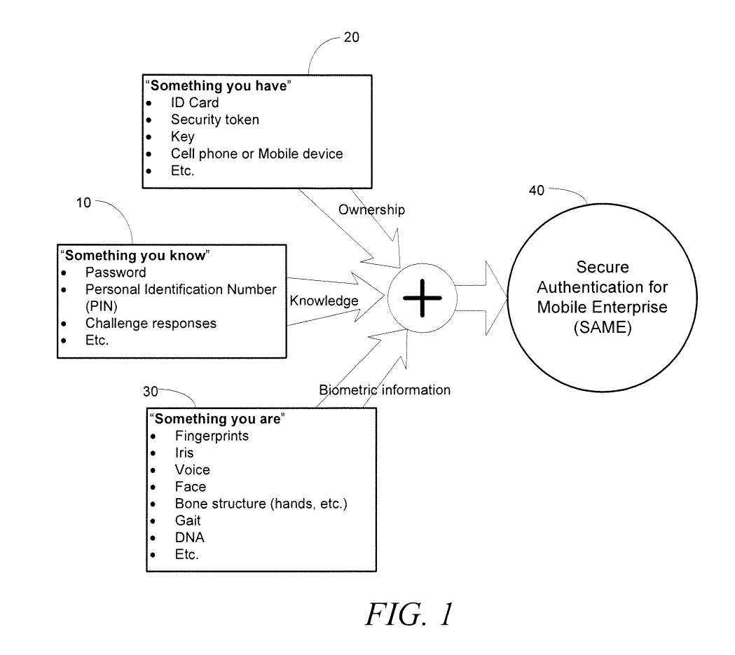

FIG. 1 is a conceptual high-level diagram of an implementation of an exemplary Secure Authentication for Mobile Enterprises (SAME) system. As shown in FIG. 1, various factors such as knowledge, possession, etc. may be used along with biometric features to authenticate a user of a mobile device. For example, certain information, which is classified as user's knowledge 10, such as user's account information including account number, password, personal identification number (PIN), challenge responses, etc., may be requested from the user. That is, the user may be prompted to enter user's account number, password, PIN, or respond to one or more challenge questions and to provide the SAME system 40 with user's challenge responses. Additionally, the user can further be identified using other items that may be in possession of the user, which are classified herein as user's ownership information 20. For example, identification information of the user's identification card (ID card), security token, key, communications device (e.g., mobile device, cell phone) or the like may be used to authenticate the user. Further, the user's biometric information 30, such as personal traits and features including the user's finger print, iris, voice, facial features, bone structures (e.g., hand structure), gait, DNA, etc. may be used to identify (e.g., identify who the user is) and/or verify (e.g., verify if the user is in fact who he/she is claiming to be) the user. The SAME Service or the disclosed authentication technique is based on at least three factors including the user's ownership, knowledge, and biometric information, which provides secure methods of authenticating users of mobile communications devices than conventional techniques.

As discussed above, a multi-factor authentication technique is used to authenticate users of the mobile communications device. For example, as shown in FIG. 1, the SAME Service employs at least three authentication factors including user's knowledge (something the user knows, such as a password), user's possession (something the user has, such as a mobile communications device), and user's biometrics (a personal trait of the user, such as voice biometrics) to identify the user of the mobile communication device. In addition to or in place of the factors outlined, other embodiments can use any other available information to authenticate (i.e., identify and/or verify) a user of a mobile device.

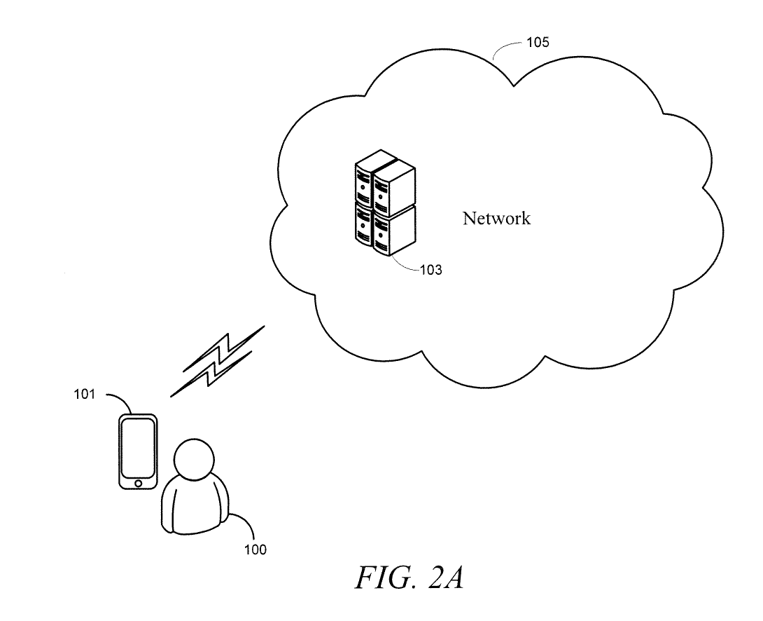

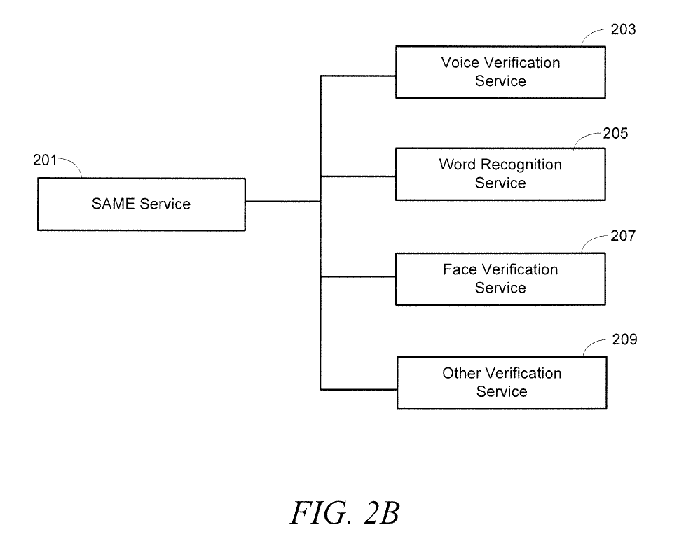

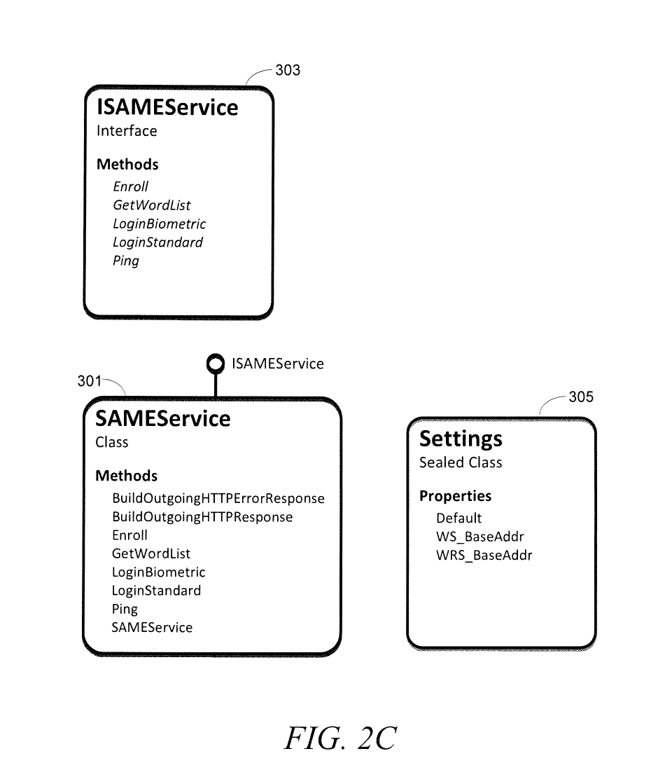

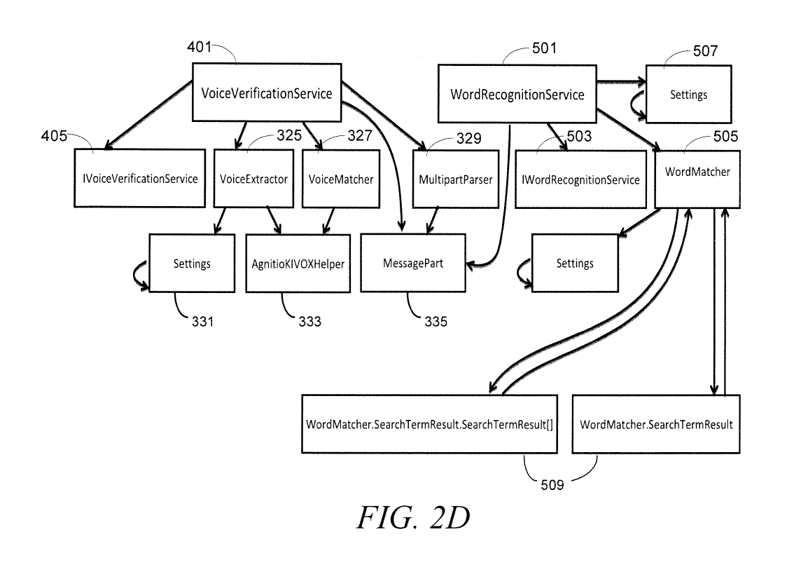

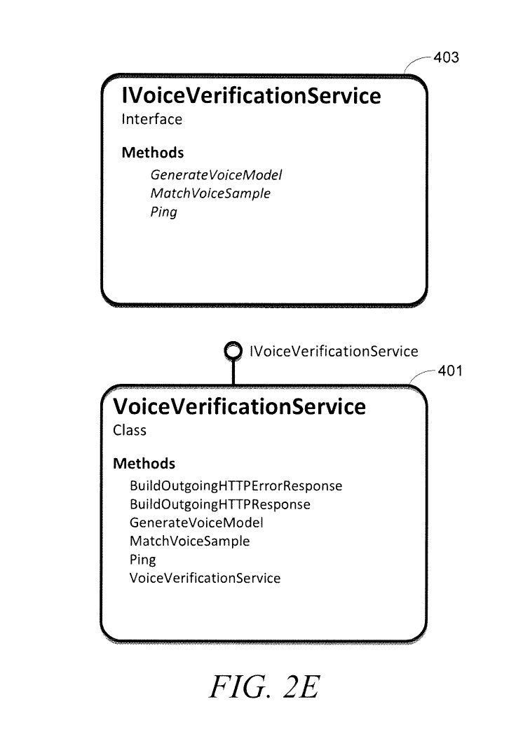

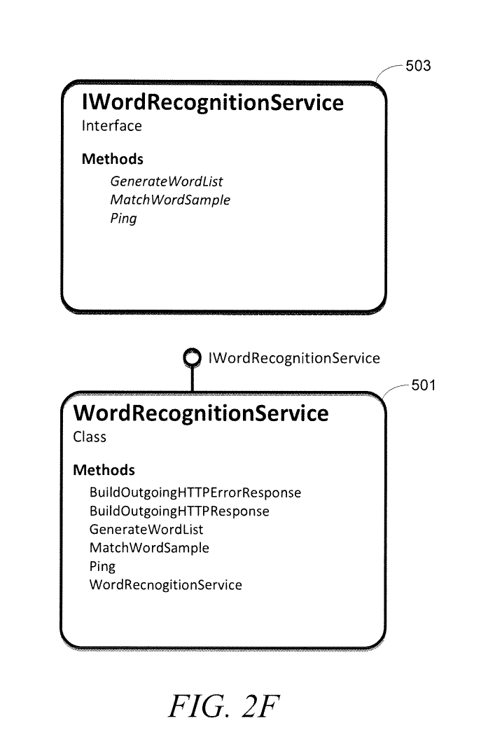

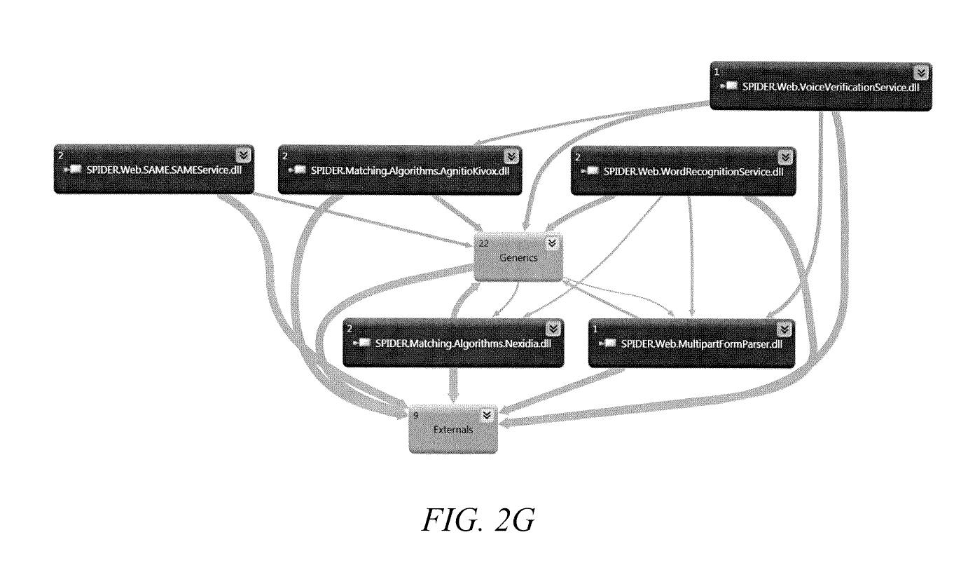

FIG. 2A is a high-level diagram of an exemplary embodiment of the present disclosure. A mobile device user 100 may wish to use a mobile device 101 (e.g., a mobile phone, a tablet, a smart phone type mobile device, or any other mobile computing device) to connect to a server 103, such as a secure banking server, on a network 105 for online banking transactions. In FIG. 2A, the mobile device 101 is shown as a smart-phone type mobile device with a camera, but it can be any mobile computing device with a user interface and a camera. The mobile device 101 is an example of a computing device that may be used for various digital communications including voice communications and data communications. The mobile device 101 herein includes a mobile phone or mobile station, personal computer, tablet computer, electronic reader, other mobile computing devices, or the like. The term “mobile device” is used generally to mean any mobile communication equipment capable of supporting the disclosed techniques herein.

The mobile device(s) can take the form of portable handsets, smart-phones or personal digital assistants, electronic readers, tablet devices or the like, although they may be implemented in other form factors. The mobile devices execute various stored mobile applications including mobile application programs or application programming interfaces (APIs) in support of receiving the SAME service on the devices. An application running on the mobile device 101 may be configured to execute on many different types of the mobile devices. For example, a mobile application can be written to execute in an iOS or Android operating system, or on a binary runtime environment for a BREW-based mobile device, a Windows Mobile based mobile device, Java Mobile, or RIM based mobile device (e.g., Blackberry), or the like. Some of these types of mobile devices can employ a multi-tasking operating system as well.

The network 105 includes a communication network including a mobile communication network which provides mobile wireless communications services to mobile devices. The disclosed techniques herein (e.g., the SAME service) may be implemented in any of a variety of available communication networks and/or on any type of mobile device compatible with such a communication network 105. In the example, the communication network 105 might be implemented as a network conforming to the code division multiple access (CDMA) type standard, the 3rd Generation Partnership Project 2 (3GPP2) standard, the Evolution Data Optimized (EVDO) standard, the Global System for Mobile communication (GSM) standard, the 3rd Generation (3G) telecommunication standard, the 4th Generation (4G) telecommunication standard, the Long Term Evolution (LTE) standard, or other telecommunications standards used for public or private mobile wireless communications. Further, the communication network 105 can be implemented by a number of interconnected networks. Hence, the network 105 may include a number of radio access networks (RANs), as well as regional ground networks interconnecting a number of RANs and a wide area network (WAN) interconnecting the regional ground networks to core network elements. A regional portion of the network 105, such as that serving mobile devices 101, can include one or more RANs and a regional circuit and/or packet switched network and associated signaling network facilities.

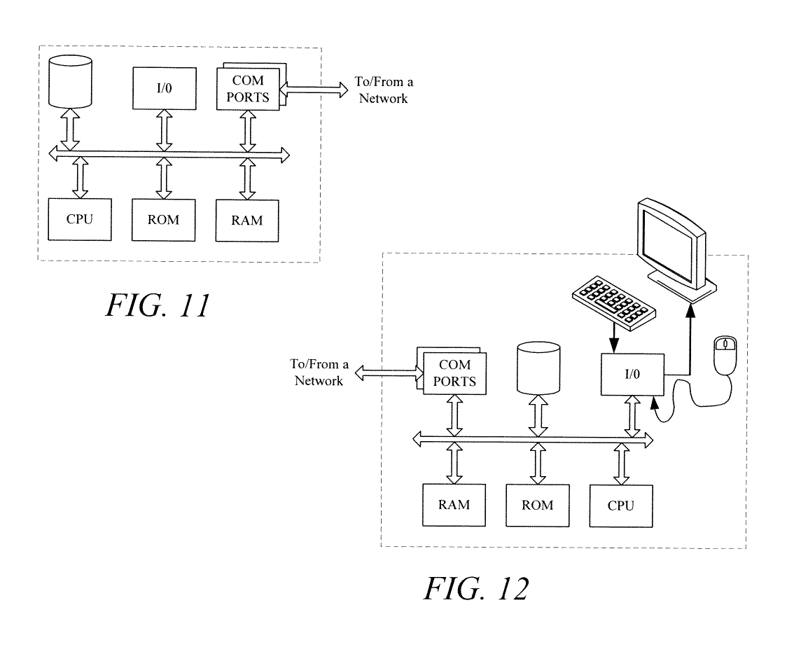

The server 103 is one or more servers implementing the disclosed authentication techniques on the network 105. As shown in FIGS. 11 and 12, the server 103 includes an interface for network communication, a processor coupled to the interface, a program for the processor, and a non-transitory storage for the program. The execution of the program by the processor of the server configures the server to perform various functions including user identification, validation, and authentication functions. An authentication application program, according to some embodiments disclosed herein, requests various authentication factors or information from the user. For example, the application program may verify the user's device (e.g., mobile phone), ask the user to answer a security question and verify the user's response, and verify user's biometric information (e.g., user's voice by asking the user to read or repeat a word or a series of words). In some embodiments, the application program may interact with a secure server side application to generate challenge/response login questions (pass phrases), send hardware identifiers (e.g., a serial number of the mobile device) to the server application, obtain voice samples from the user (e.g., using a microphone built into the mobile device) and send them to the server. The application program may obtain other biometric information such as facial features of the user (e.g., using a camera built into the mobile device) to obtain, transmit, and verify the authentication information.

In the example shown in FIG. 2A, and as discussed in detail below, the server 103 implements functions such as the Secure Authentication for Mobile Enterprises (SAME) Service. The SAME Service may include web services application programming interfaces (the “SAME APIs”) that deliver multi-factor authentication services to mobile computers (e.g., mobile devices, smart phones, tablets, etc.). An application programming interface (API) is a software implementation of a protocol intended to be used as an interface by software components to communicate with each other. Generally, an API is a library that includes specification for routines, data structures, object classes, and variables. The SAME APIs are designed to be integrated into various applications such as banking applications on the mobile devices and are biometrically enabled, cryptographically secure, and designed specifically to support authentication of users of devices like smart phones for the SAME service. The SAME APIs do not require any additional hardware to be carried or used by users and the procedures associated with the SAME APIs may be performed using the mobile device that the user already owns. The SAME APIs may run in a data center or operate as a managed service running in cloud data centers.

As discussed earlier, the SAME APIs use a multi-factor biometric based authentication technique to verify identity of a user with high confidence. For example, the identity of the user of the mobile device 101 is verified using factors including, but not limited to, possession information (e.g., something the user has, that is, the mobile device 101 that is in possession of the user), knowledge information (e.g., password, personal identification number (PIN), or challenge question and response), and biometric information (e.g., biometric verification through voice biometrics or facial recognition). However, additional factors can be used, such as geographic location of the mobile device 101, usage pattern of the user, etc. Further, in exemplary embodiments that employ the user's voice biometric to verify the mobile device user, word recognition techniques are used to ensure that replay attacks (e.g., by an imposter replaying a user's reordered voice) are defeated. In other embodiments, the procedures carried out by the SAME APIs are secured with cryptographic algorithms known in the art to ensure end-to-end integrity.

In some embodiments, the SAME APIs may include a set of server-side services that support multi-factor biometric based authentication of user identities. Authentication factors supported by the SAME APIs may include password/PIN, device identifiers, biometric (e.g., speaker ID or voice biometrics, facial biometric features, etc.), and a geographical location based on the location of the device.

The client-side of the SAME APIs may include an application interface or an application program that performs user interface activities and collects information related to the multi factors that are used for authentication. The client-side of the SAME APIs may be executed on any communication device known in the art including, but not limited to, smart phones and tablet computers or the like. The client-side application relays the information to the server-side of the SAME APIs for computation and authentication. It is noted that the phrases “SAME Service” and “SAME APIs” are used to refer to software or hardware implementations of various aspects of the multi-factor biometric based authentication techniques disclosed herein.

FIG. 2B is a high level diagram of some of the services that may be offered by the SAME service. As shown, the SAME service 201 includes voice verification service 203, word recognition service 205, face verification service 207, and other verification service 209. Other verification service 209 known in the art may include verification service based on geographical location of the mobile device 101. Each service is implemented using hardware or software or any combinations thereof to perform intended functions. The voice verification service 203 provides functionalities relating to verifying or authenticating voice samples or voice models of users of mobile devices. The word recognition service 205 provides functionalities relating to verifying or authenticating identities of the users of the mobile devices using speech samples of the users, based on a randomly generated word list, which is presented to the users on the mobile devices. The face verification service 207 provides functionalities relating to verifying or authenticating the identities of the users of the mobile devices, based on recognized facial features of the users of the mobile devices.

FIGS. 2C-2G illustrate high level diagrams of some of the services that may be included in the SAME service or SAME APIs. It is noted that one of ordinary skill in the art would understand that representations in FIGS. 2C-2G can be easily implemented using various computer programming languages, such as C, C++, Java, object-oriented languages, scripting languages, etc. Also, hardware, alone or in combination with software, can be used to implement various aspects of the SAME service as shown in FIGS. 2C-2G.

As shown in FIGS. 2C and 2D, using object-oriented programming language, the SAME service may be provided as a traditional port 80 web service (i.e., a web based service), which may be implemented in a class called SAMEService class 301. As shown in FIG. 2C, the SAMEService class 301 exposes an interface that is, in turn, served by a web server to external clients (this is the ISAMEService interface 303).

In addition, the SAMEService class 301 may use multiple helper classes, such as Settings class 305 and WordExtractor class (not shown). In some embodiments, the Settings class 305 may be used to read and save configuration settings used by the SAMEService class 301. The WordExtractor may be a class that the SAMEService class 301 uses to read a word lexicon file into memory. These words may be used to provide a probe word list to a user of a mobile device 101 during authentication.

As shown in FIG. 2D, the SAME service (or APIs) also includes various other services that can be utilized by the SAMEService class 301. These services may be divided into separate services to aid in parallelizing the processing to ensure that the solution can scale properly to manage large numbers of mobile device users. These services may run on the same server hardware configured to execute various functions including functions of SAME Service or on separate machines in a distributed computing environment. These services may include services such as a voice verification service (“VVS”), which may be implemented via VoiceVerificationService class 401 in FIG. 2E, and a word recognition service (“WRS”), which may be implemented via WordRecognitionService class 501 in FIG. 2F.

The VVS class 401 is used to manage various features such as creation of voice models from human speech recordings of a user of a mobile device 101 and comparison of newly-acquired speech recordings from the user to previously computed voice models. As shown in FIG. 2E, the VVS class 401 exposes an interface function, IVoiceVerificationService 405, which compares newly-acquired speech recordings from the user to previously computed voice models for verification purposes. That is, the VVS class 401 presents its interface through the web server by exposing an IVoiceVerificationService interface 405. Further, in certain embodiments, the VVS service may make use of various classes. For example, the VVS class 401 may use other classes such as VoiceExtractor 325, VoiceMatcher 327, and MultipartParser 329, as shown in FIG. 2D.

The VoiceExtractor 325 and VoiceMatcher 327 may shield the details of the software library used to perform voice biometric computations from VoiceVerificationService 401. This is done to ensure that the voice biometric libraries vendors may be changed without having to rewrite or reproduce the SAMEService or VoiceVerificationService 401.

The VoiceExtractor 325 manages creation of voice models from recorded speech. In some embodiments, the VoiceExtractor 325 may use multiple helper classes such as Settings 331 and voice biometric tools such as a AgnitioKIVOXHelper 333. The AgnitioKIVOXHelper 333 is a wrapper class that calls voice biometric libraries provided by a voice biometric vendor. In some embodiments, the AgnitioKIVOXHelper class 333 may be part of commercially available Agnitio's KIVOX software library.

In some embodiments, the VoiceExtractor 325 may use the AgnitioKIVOXHelper 333 to compute a voice model from recorded speech. In certain embodiments, the VoiceMatcher 327 may also use the AgnitioKIVOXHelper 333 to interface with the voice biometric libraries for voice comparison computations (instead of model creation).

In some embodiments, the MultipartParser 329 may be used to manage the receiving of information from the web server. Specifically, when form information and large files are transmitted across the Internet through the web server, they may be passed as a Multipurpose Internet Mail Extension (MIME) multipart message. MultipartParser 329 and its child class, MessagePart 335, may handle low-level details of converting this information to a form usable by VVS and WRS classes.

The WRS class 501 is used to manage comparison of the audio recordings of the user's speaking of the probe word list to the original text word list that was presented to the user during an enrolment process, which is described in detail below. In some embodiments, the SAMEService may call to process the voice biometric computation. As shown in FIG. 2F, the WRS class 501 exposes its interface through the web server using the IWordRecognitionService interface 503. In certain embodiments, the WRS may use the Settings class 507 (similar to VVS and SAMEService) to manage its configuration. The WordMatcher class 505 may shield the details of the vendor library uses to perform the word recognition process.

As shown in FIG. 2D, the WordMatcher 505 exposes multiple (e.g., three) data structures that are used to pass in the probe word list and receive data on where each word was located in the audio stream, along with recognition confidence scores for each word. That is, the WordMatcher 505 uses two additional methods or functions. For example, WordMtacher.SearchTermResult.SearchTermResult[ ], and WordMatcher.SearchTermResult[ ] 509 are used. The data structures may be used to manage this information.

FIG. 2D is a high level diagram of the exemplary SAME service and its interface functionality for software implementation. In the embodiment shown in FIG. 2D, the SAMEService is the main service that manages communications with a client application and a process of performing authentication of users of mobile devices. The SAMEService is implemented via SAMEService class 301. In certain embodiments, the primary communication of the SAMEService may be through a web service, using the ISAMEService interface 303.

From programming perspectives, the ISAMEService may expose its various methods to its client application. For example, as shown in FIG. 2C, in one embodiment, methods such as Enroll, GetWordList, LoginBiometric, LoginStandard, and Ping may be exposed by the ISAMEService 303. The Enroll method is used to invoke various procedures for an enrollment process of a user of a mobile device for a multi-factor biometric based authentication service. The Enroll method is used to collect the user's information, compute the voice model, etc. The LoginBiometric method is used to perform multi-factor authentication including user's biometric information (e.g., voice). The LoginStandard method is used to perform authentication with just non-biometric factors (i.e., login ID, password, challenge responses, etc.). The GetWordList method is used to query the SAMEService to obtain a randomly generated probe word list for presenting the probe word list to the user of the mobile device. The Ping method is used to verify that the SAME service is running and accessible to the user of the mobile device.

In some embodiments, these interface methods map directly to internal functional methods. In other embodiments, additional internal methods may be utilized to manage communications with the web server.

FIGS. 2E and 2F are high level diagrams illustrating exemplary implementations of the VoiceVerificationService class and WordRecognitionService class.

FIG. 2E shows an exemplary implementation of VoiceVerificationService class. The voice verification service is provided via the VoiceVerificationService class 401 and its associated interface function 403. In the exemplary embodiment, the VoiceVerification class 401 is called (or invoked) by the SAMEService class 301 to perform voice verification functions, such as voice biometric model extraction and comparisons. The VoiceVerificationService class 401 communicates through a web service by exposing its IVoiceVerificationService interface 403, which may offer various other methods including GenerateVoiceModel, MatchVoiceSample, and Ping. The GenerateVoiceModel method takes a portion of recorded speech and returns a voice model computed from the recorded speech. The GenerateVoiceModel method is a wrapper that calls a voice biometric library to create a voice model. The MatchVoiceSample method takes the voice model and portion of recorded speech and returns a score that indicates how well the speech matches the voice model. In some embodiments, the MatchVoiceSample may be a wrapper that calls the matching function from the voice biometric library. The Ping method allows external callers to verify that the service is running and accessible. In some embodiments, these interface methods may map directly to internal functional methods. In certain embodiments, additional internal methods may be utilized to manage communications with the web server.

FIG. 2F is a high level diagram illustrating an exemplary implementation of WordRecognitionService class. The word recognition service is provided via WordRecognitionService class 501 and its associated interface function 503. In the exemplary embodiment, the WordRecognitionService class 501 is called by the SAMEService class to perform speech recognition and comparisons. The WordRecognitionService class 501 communicates through the web service by exposing its IWordRecognitionService interface 503. The IWordRecognitionService interface 503 offers various methods, such as GenerateWordList, MatchWordSample, and Ping. As noted earlier, the ping method allows external callers to verify that the service is running and accessible.

The GenerateWordList method is used to generate a list of probe words to pass to a client application running on a mobile device 101. The MatchWordSample method takes the list of probe words and a portion of recorded speech, and search the speech for the words in the list.

In some embodiments, the MatchWordSample may return a time offset for each word (e.g., how many seconds into the audio portion the word was found) and a confidence score for each word. In some embodiments, this information may be used to compute an overall confidence score that indicates how closely the words spoken by the user match the words the user was asked to speak. In certain embodiments, these interface methods may map directly to internal functional methods. Additional internal methods may be utilized to manage communications with the web server.

The GenerateWordList method functions in a similar manner as the GetWordList method. The GenerateWordList method may be an external interface and visible through the web service. In certain embodiments, the GetWordList method may be used as an internal implementation. The GetWordList method may read entire contents of a word list (“lexicon”) into the memory at initialization and assign a serial number to each word. It may also present a caller with a list of words and specify the number of words that should be presented to the caller.

Moreover, in some embodiments, the GetWordList method may select a random number between 0 and the number of words in the lexicon, and check to see if that number has already been selected during this call. If yes, it selects a number again, and keeps trying until it generates a number that has not already been used during this call. Once a number is obtained, the GetWordList method retrieves the word with that serial number and add that to the output list. This process may be repeated until the required number of words is generated. At that point, the GetWordList method presents the words to the caller.

FIG. 2G is an illustration of an exemplary assembly diagram for the SAME API. The SAME Service software may be packaged into a number of files, called assemblies for execution by one or more processors in a general computing device (i.e., a server, a client terminal, a mobile device, etc.). Each assembly tile contains one or more classes or functions. These assemblies are loaded at runtime to provide the SAME Service. Examples of some of the assemblies files that are used to make up the SAME APIs and their corresponding functions are outlined below:

| Assembly Files | Functions |
|---|---|
| SPIDER.Web.SAME.SAMEService.dll | Contains SAMEService |
| SPIDER.Matching.Algorithms. | Contains the |
| AgnitioKIVOX.dll | AgnitioKIVOXHelper class |
| SPIDER.Web.Matching.Algorithms. | Contains the |
| Nexidia.dll | WordMatcher class |
| SPIDER.Web.VoiceVerificationService.dll | Contains the |
| | VoiceVerificationService |
| | class |
| SPIDER.Web.WordRecognitionService.dll | Contains the |
| | WordRecognitionService |
| | class |
| SPIDER.Web.MultipartFormParser.dll | Contains the |
| | MultipartParser and |
| | MessagePart classes |

In some embodiments, the SAME API may use other classes provided as part of the software development environment (e.g., Microsoft development or the like), which are represented above as Generics and Externals and are standard library components.

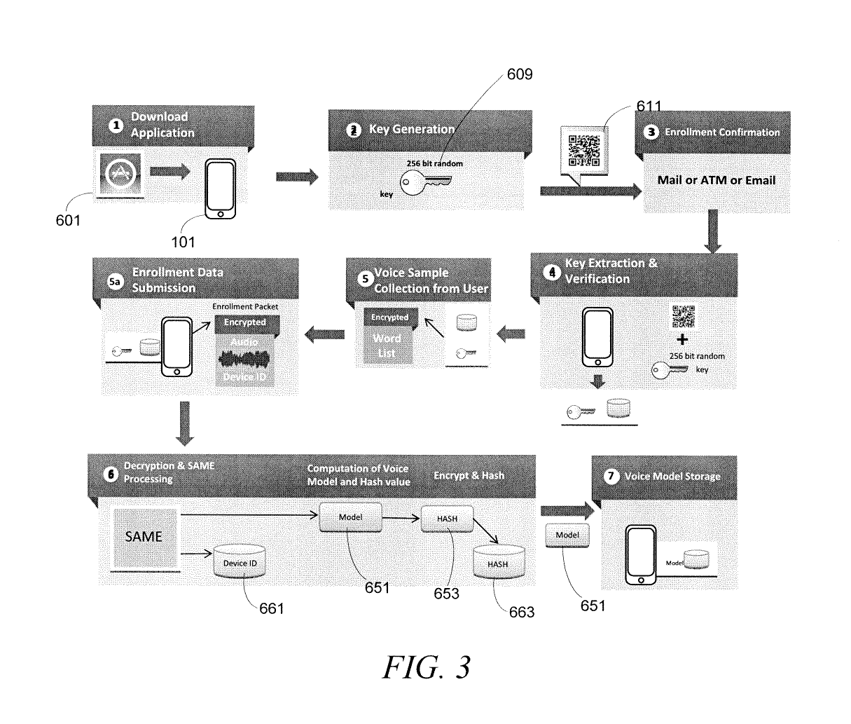

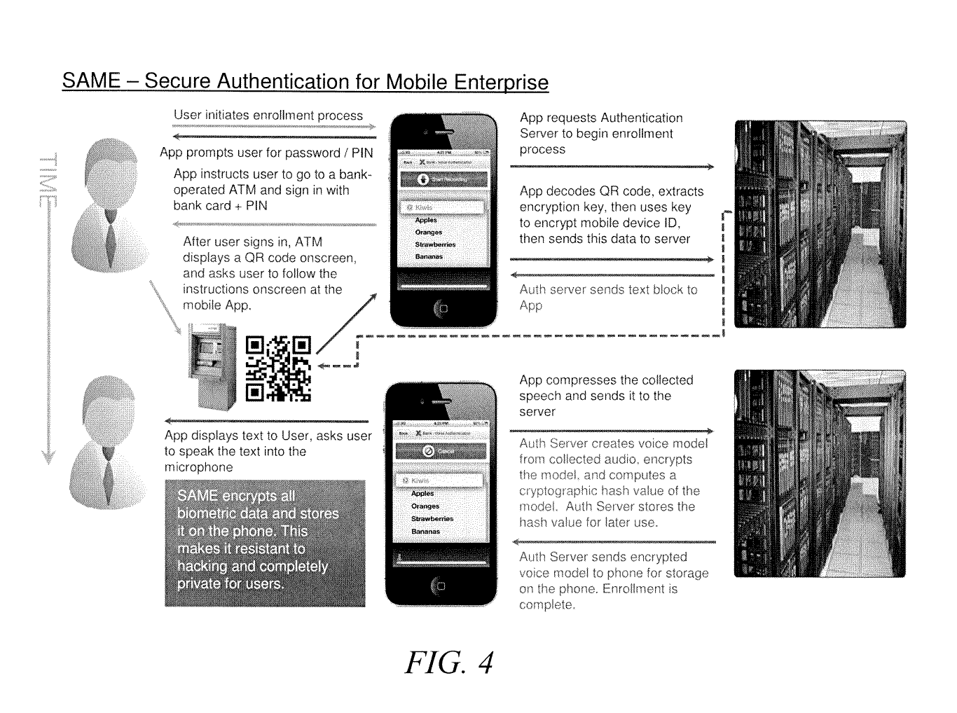

FIGS. 3 and 4 are high level diagrams illustrating an exemplary sequence of an enrollment process for a multi-factors, biometric based authentication service. As shown in FIG. 3, at Step 1 (Download Application), a mobile application or APIs 601 for authentication of a user is downloaded into a mobile device 101. At Step 2 (Key Generation), a 256-bit random encryption key is randomly generated for use and encoded into a Quick Response (QR) code. In other implementations, the 256-bit random encryption key can be encoded in other types of messages to the mobile device. Both the mobile device and downloaded mobile application may be enrolled with an authentication server on a network (e.g., authentication server of a financial institution or bank). During enrollment, the server may obtain various authentication related information or factors such as user's biometric, account password, challenge question and answer, etc. from the user of the mobile device 101. Also, in other embodiments, encryption keys of different length or types can be used instead of the 256-bit random encryption key. In other embodiments, the encryption key can be sent to the mobile device 101 without using the QR code, for example, using another type of coded message, pictures, etc.

As shown, once the enrollment is initiated by the user, the mobile application submits a request to an authentication server on the network (e.g., an authentication server of a bank) to begin the enrollment process. The mobile application prompts the user for a password or pin for the user's account. In the example, at Step 3 (Enrollment Confirmation), the mobile application instructs the user to go to a nearby automatic teller machine (ATM) and login with a bank card and pin. After the user signs into the ATM, the ATM displays the QR code 611 on a display of the ATM and asks the user to follow the instructions to read the QR code.

It is noted that QR code is the trademark for a type of matrix barcode or two dimensional bar code, which was first designed and used in the automotive industry in Japan. The QR code consists of square dots arranged in a square grid on a white background. Using different types of data such as numeric, alphanumeric, bytes/binary, or other extensions, information can be encoded. A QR code is read by an imaging device, such as a camera or a smart phone with imaging capability. The information encoded in the QR code can be extracted using software from recognized patterns present in a scanned image.

In the example, the QR code 611 includes the encryption key 609 (“a first encryption key” or “a voice sample key”) as part of embedded information for use in the SAME based authentication. As noted earlier, in the example the encryption key 609 is a 256 bit randomly generated encryption key. Encryption is a process of encoding information in such a way that hackers cannot read it without the use of a key. Encryption and decryption and use of an encryption or decryption key are well known in the art and thus are not described herein in detail. The 256 bit randomly generated encryption key is exemplary and other types or length encryption keys can be used (e.g., 128-bits, 193-bits, or other types of Advanced Encryption Standard (AES) keys). The encryption key 609 is used to encrypt user's enrollment information, such as a mobile device identification (e.g., a mobile device ID), user account and password, PIN, and other data for secure transmission over the network.

It is also possible to use the encryption key in a digital signature operation, to digitally sign the enrollment information. In this case, the enrollment information is not directly encrypted, yet the authentication server can validate that the enrollment information was signed by the correct key. Either process allows the authentication server to verify that the user was in possession of the correct encryption key.

In the exemplary embodiment, the user uses the mobile device 101 to scan the QR code 611. Upon scanning in the QR code 611, at Step 4 (Key Extraction & Validation), software of the mobile device 101 decodes the QR code 611 and extracts the encryption key 609 from the QR code 611. Using the encryption key 609, the enrollment information is encrypted on the mobile device 101 and the encrypted enrollment information is forwarded to the authentication server on the network.

In the exemplary embodiment, the encryption key 609 extracted from the QR code 611 is used to encrypt the entire enrollment packet, but in other embodiments, part of the enrollment packet may be encrypted for transmission over the network, or the enrollment packet may be digitally signed for transmission over the network.

At Step 5 (Voice Sample Collection from User), the authentication server generates and forwards a text block to the mobile application on the mobile device 101. The text block is a randomly generated text block or contains a predefined list of words for the user. At Step 5a (Enrollment Data Submission), the mobile application displays the text block to the user and asks the user to read or speak the text block into a microphone (e.g., a built-in microphone of the mobile device). The mobile application on the mobile device 101 collects user's speech data, encrypts the collected user's speech data using the encryption key 609 (or the voice sample key), and forwards the encrypted data to the authentication server on the network to determine a voice model of the user (i.e., as a template of voice biometric of the user) for authentication purposes. In some embodiments, the collected, encrypted speech data may be compressed by the mobile device before they are sent to the authentication server.

At Step 6 (Decrypting and SAME Processing), the encrypted data is decrypted and various information including the device ID of the mobile device 101 is recovered (after decryption) and stored in one or more databases. For example, the recovered device ID of the mobile device 101 is stored in a database 661. Further, the authentication server creates a voice model 651 based on the collected speech data, encrypts the voice model 651 using a second encryption key (“a voice model key”), which is different from the encryption key 609, and computes a cryptographic hash value 653 of the voice model 651 for storage in a database 663 and later use. The voice model key is not stored in the mobile device, which only stores an encrypted version of the voice model. This provides additional protection against tampering of the voice model. The word “voice model” herein is defined as data, features, a mathematical representation, or the like that is extracted from audio or voice samples of a user during enrollment. The voice model of a user is unique to the user and sometimes called as a voice template for authenticating the user.

The database 663 includes hash values of one or more voice models of users of mobile devices. The hash value of the voice model can be obtained as a result of computing a “hashing algorithm” on the set of voice samples or the voice model. The word “hash value” thus is generally referred herein to a mathematical reduction of data such that any change to the original data will result in an unpredictable change in the hash value, which enables detection of a match or no match by comparing of hash values. Later during verification of the user, a hash value for the voice model of the user is retrieved from the database 663 and for integrity of the voice model, compared with a newly computed hash value of the voice model received from the mobile device. This comparison of hash values ensures the integrity of the voice model for the registered or enrolled user.

Thus, the authentication server stores only the computed hash value 653 for the voice model for later use, while discarding the received speech data from the mobile device 101. The authentication server forwards the determined voice model 651 (which is encrypted with a different encryption key than the encryption key 609) to the mobile device 101 for storage in memory of the mobile device 101 and discards its local copy of the voice model 651. As a result, only a single copy of the encrypted version of the voice model 651 of the user is stored in the mobile device 101, not in the authentication server. Thus, even if the authentication server is compromised (or breached by a hacker) on the network, the authentication information, such as the voice model 651 is not compromised. By storing the encrypted voice data including the voice model 651 in the mobile device 101, the data remain resistant to hacking and completely private for the user of the mobile device 101.

In the exemplary embodiment, an encrypted voice model is sent back and forth between the authentication server and the mobile device 101. In this way, user privacy is maintained since the user's biometric information, such as voice samples, is stored and carried by the user in the mobile device 101, not in the authentication server on the network. Only the hash value of the voice model 651 is stored in the authentication server on the network.

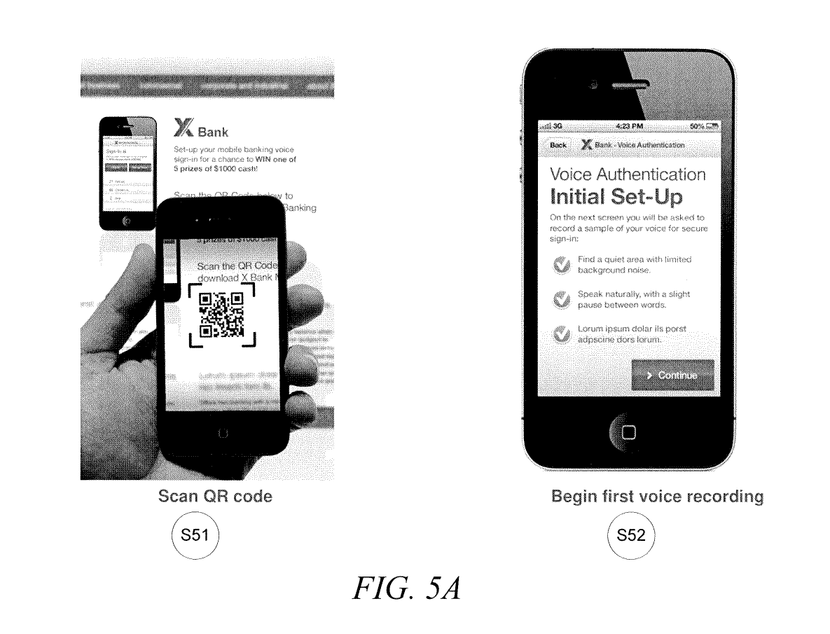

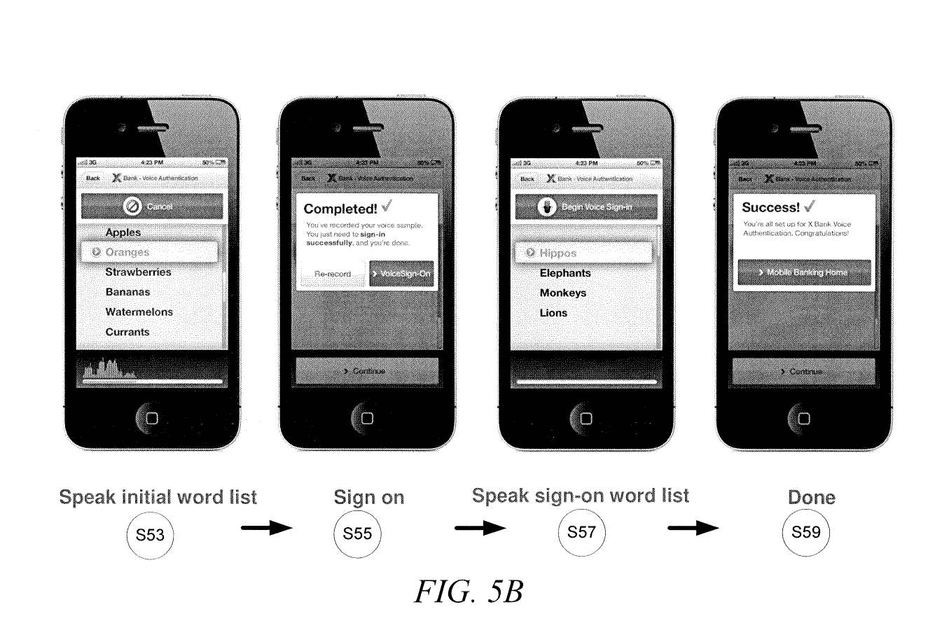

FIGS. 5A-5B illustrate high level exemplary displays on the mobile device for enrolling a user of the mobile device for voice biometric based authentication. It is assumed that the user wishes to enroll in the voice biometric based authentication service for a banking service (e.g., online banking, etc.). As shown in FIG. 5A, at S51, for an initial enrollment process of the user, the user is directed to scan a QR code displayed at an ATM or other facility operated by the bank. The QR code is automatically scanned as the user places the mobile device over the QR code. The mobile device internally reads the QR code and extracts information from the QR code including an encryption key. At S52, the user is prompted to start a voice recording session to continue the enrollment process. Although not shown in FIGS. 5A and 5B, the mobile device receives a list of words and displays to the user so that the user is prompted to read aloud or speak each word displayed on the mobile device. As the user speaks the list of words, at S53, recordings of user's voice samples of the words are made by the mobile device and stored in its memory. Alternatively, the user may be asked to record a voice sample by reading a text block displayed by the mobile device. The recordings of one or more voice sample(s) are captured, at S53-S57, encrypted using the encryption key, and sent to the network for determining a voice model of the user based on the voice samples. The mobile device then receives the determined voice model of the user from the network and stores it in memory of the mobile device for later use. After storing the determined voice model in the memory of the mobile device, the user is notified that the enrollment process is complete, at S59. Alternatively, after the voice samples are recorded, the mobile device may indicate to the user that he/she may now use voice biometric to sign in to a secure server for an online banking service (e.g., an authentication server of a bank).

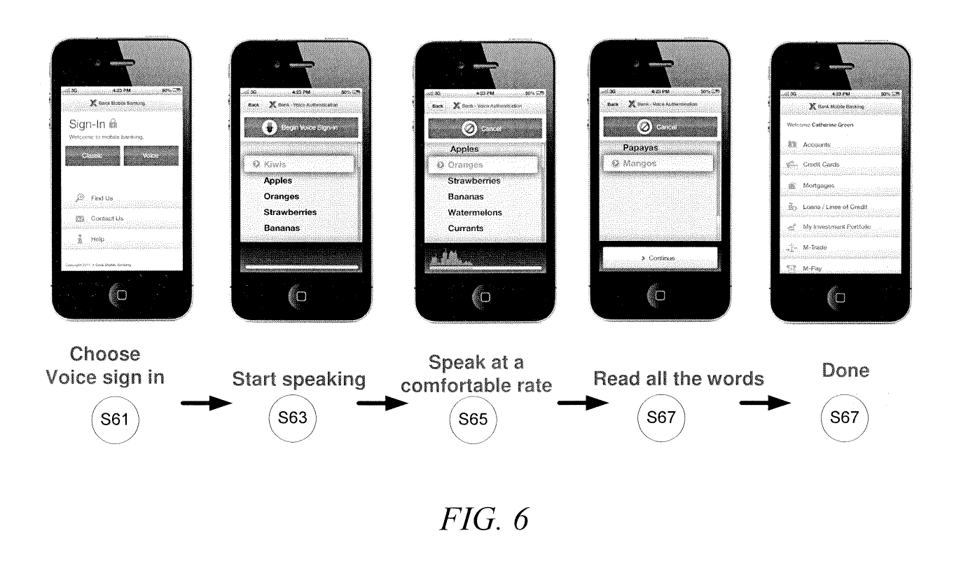

FIG. 6 illustrates high level exemplary displays on the mobile device for signing in to the secure server using voice biometric of the user after the enrollment process of the user has been completed in FIGS. 5A and 5B.

As shown at S61, the user of the mobile device selects to sign in for the online banking service, using voice authentication. The mobile device displays a list of words to the user so that voice samples of the user can be captured for authentication. The list of words is generated and provided by the authentication server on a network. The list of words includes words that are randomly generated using a dictionary or lexicon. At S63-S65, the user starts speaking into a microphone of the mobile device or reads (i.e., speaks) each word presented by the mobile device, at a comfortable rate. Alternatively, the user may be presented with a word block and read the word block at a comfortable rate. At S67-S69, once all the words in the list are read, the mobile device or SAME API authenticates the user and allows the user access to his/her bank account.

As described earlier, the authentication is performed at the authentication server, based on the captured voice samples of the words (or the word block) and the voice model of the user, which was stored in the mobile device during the enrollment process. The captured voice samples and the voice model of the user are encrypted on the mobile device and are sent to the authentication server for comparison and/or verification of the identity of the user. Alternatively, the captured voice samples are encrypted on the mobile device and sent along with the retrieved, encrypted voice model of the user to the authentication server. It is noted that in the exemplary embodiment, the mobile device does not have an encryption or decryption key for the encrypted voice model of the user because the voice model is encrypted (or decrypted) only at the authentication server using a separate, distinct encryption key (i.e., a voice model key) which is different from the encryption key (i.e., a voice sample key) used in encrypting the voice samples by the mobile device for generating the voice model of the user, which enables detection of tampering of an encrypted voice model. In the example, the authentication server does not keep a permanent copy of the voice model of the user. Rather, the authentication server keeps only a hash value of the encrypted voice model for a later integrity check of the voice model received from the mobile device. After successful authentication of the voice samples (e.g., after a successful integrity check of the voice model and successful comparison of the voice samples against the voice model), access to the authentication server is granted and the user is allowed to continue with the online banking transactions. It is noted that in the embodiments described herein, the authentication steps including biometric verification are performed on the server side (e.g., by the authentication server) and not performed locally in the mobile device.

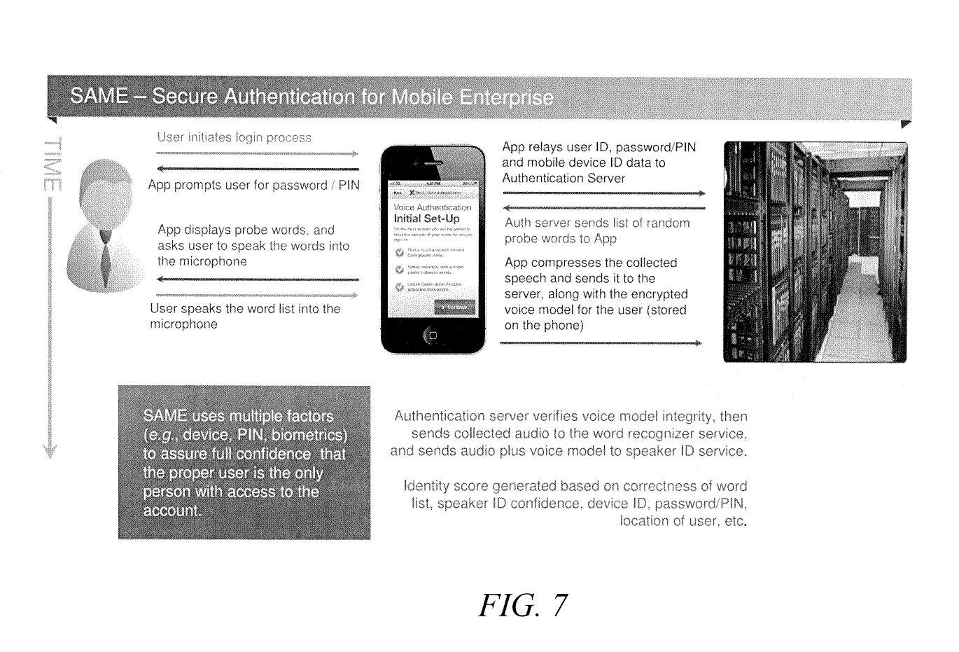

FIG. 7 shows another illustration of an exemplary process of authenticating a user using voice biometric data. A user of the mobile device initiates a login process using a mobile application on the mobile device. In response, the mobile application prompts the user for verification information, such as a user ID, password, and/or pin, obtains this information from the user, and relays the obtained user ID, password, or pin along with an identification of the mobile device to an authentication server capable of providing the SAME service on a network. The authentication server forwards a text block, including a list of randomly generated words to the mobile application on the mobile device. The mobile application displays the words to the user and asks the user to speak the words into a microphone of the mobile device. The user speaks the words into the microphone and the mobile application collects and forwards the user's speech to the authentication server via SAME APIs. In some embodiments, the mobile application may compress the user's speech or voice samples before forwarding them to the authentication server. Further, the mobile application forwards an encrypted voice model for the user (previously stored in the mobile device) along with the speech data to the authentication server.

The authentication server verifies integrity of the received voice model (i.e., by comparing a stored hash value of the voice model with a newly computed hash value of the received voice model from the mobile device), sends collected voice samples to a word recognizer service, and sends the voice samples plus voice model to a speaker identification (ID) service. The speaker identification service determines an identity score based on correctness of the word list, device ID, password, PIN, location of user, etc. and speaker ID confidence. By using multiple factors (e.g., device ID, password, PIN, user's biometric information), embodiments of the disclosed techniques obtain full confidence that the proper user is the only person with access to a user account.

Certain embodiments may generate a random set of words during enrollment and also during verification, each time a user accesses the authentication system. Since the words are not stored for later use and are randomly generated each time, these embodiments reduce the risk of “play back” by adversaries.

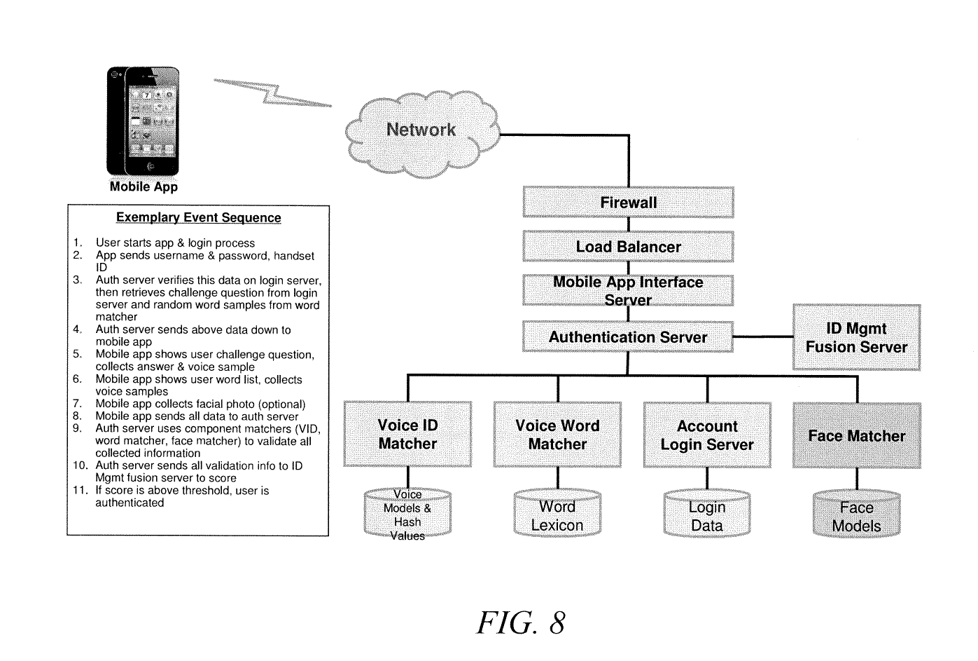

FIG. 8 is a high-level block diagram further illustrating an exemplary implementation of the SAME service on a network or server side implementation for biometric based authentication. A user (not shown) of the mobile device initiates a login process for online transactions by starting a mobile application for the SAME service. In response, the mobile application prompts the user for login information such as username and password and forwards the login information along with the device ID of the mobile device to the authentication server via the network (e.g., through the network, firewall, load balancer, mobile application interface server, etc.). The authentication server verifies the received data on an account login server, that is, by retrieving account information relating to the user from the account login server and comparing with the received data. The account login server holds login data of a plurality of users and challenge questions and responses in a login database. The account login server retrieves one or more challenge questions from the account login server for presenting to the user on the mobile device. Alternatively, the login data and challenge questions and answers can be stored in separate databases or in a distributed computing environment. The authentication server also obtains random word samples from the voice word matcher. The random word samples may be generated by the voice word matcher using a word lexicon stored in a database. In one embodiment, the voice word matcher can be implemented as a software component running on the authentication server. In another embodiment, the voice word matcher can be implemented in a separate computing device other than the authentication server.

The authentication server is configured to forward the retrieved challenge questions to the mobile application on the mobile device for presenting them to the user. The mobile application displays to the user the retrieved challenge questions and collects answers from the user. In the example, the authentication server is also configured to forward the generated random word samples, as a list of words for the user, back to the mobile application running on the mobile device. The mobile application collects user's speech data in the form of a voice sample from the user. That is, the mobile application displays the list of randomly generated words and prompts the user to read (or speak) each word to collect voice samples from the user. The collected user's speech data is sent to the authentication server along with the retrieved voice model of the user from the mobile device. The integrity of the received voice model of the user is checked using a corresponding hash value stored in a hash value database and a newly computed hash value of the received voice model. The hash value database includes, among other things, hash values of voice models of different mobile device users.

In some embodiments, the mobile application may collect facial features of the user (e.g., facial photo) using its camera. The facial features of the user can be collected separately or at the same time when the user reads the list of randomly generated words. Other biometric data, such as fingerprints, iris features, bone structures (hands, etc.), gait, DNA, etc. of the user can be collected as the user's biometric information for authentication purposes. The collected biometric information is forwarded from the mobile device via its mobile application to the authentication server over the network.

The authentication server uses one or more of the component matchers, such as the voice ID matcher, voice word matcher, facial feature matcher, etc. to validate all collected information. In the embodiment described in FIG. 8, the voice ID matcher and voice word matcher are used to validate the identity of the user, for example, validating the user's identify using the user's speech samples and voice model. The face matcher is an optional component, which determines whether received facial features match with the user's face model. The word “face model” herein is defined as data, features, or a mathematical representation or the like that is extracted from obtained face features of a user during enrollment. The face model of a user is unique to the user and sometimes called as a face template for authenticating the user. In the example, the validation results of the voice ID matcher and voice word matcher are forwarded from the authentication server to an ID Management Fusion Server which computes a match score for the user based on the validation results. The ID Management Fusion Server (ID MFS) is a placeholder for a service that would accept as its input all of the identity related information collected during the verification process and return a score indicating a confidence level that the user is the same person who enrolled in the biometric authentication service. The match score is compared to a predetermined threshold. If the match score is above a threshold, the user is authenticated and the successful result is sent to the mobile application running on the mobile device. If the match score is below the threshold, then the authentication server may abort the authentication process and inform the mobile application of the authentication result, or the authentication server may request additional biometric data from the user.

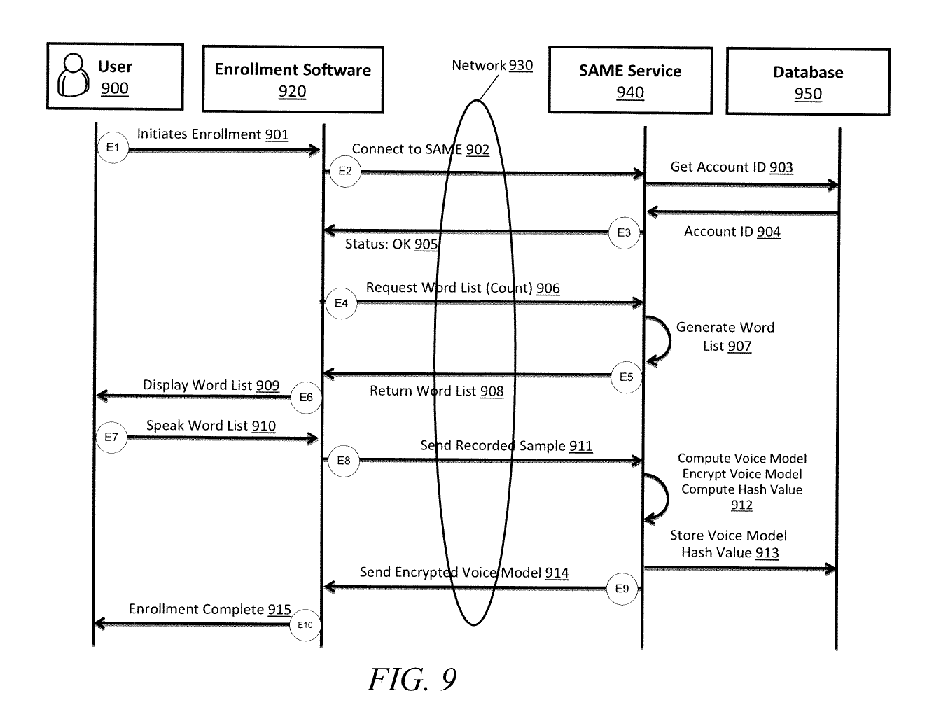

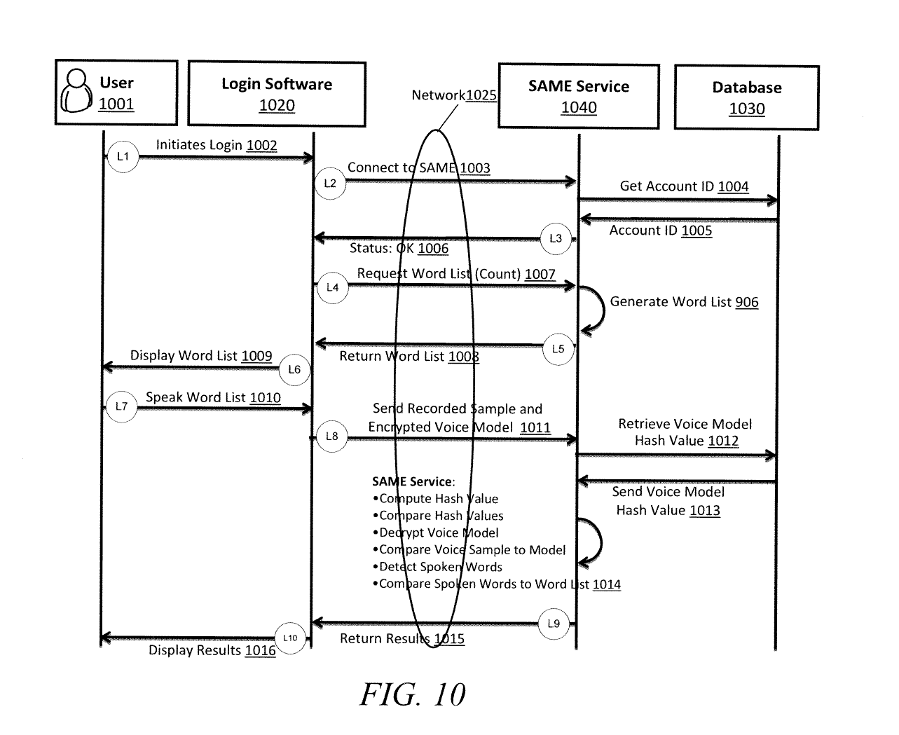

FIGS. 9 and 10 are flow diagrams of exemplary embodiments of the SAME service. FIG. 9 illustrates procedures for an exemplary enrollment process using SAME APIs. At E1, a user 900 uses a mobile device, such as a mobile communications device, to initiate an enrollment process 901 through a mobile application, such as enrollment software 920 running on the mobile device, with an authority such as a financial institution.

At E2, the enrollment software 920 on the mobile device connects 902 over a network 930 to the SAME service 940, which is implemented in one or more servers on the network 930. Once a connection is established, the SAME service 940 may issue a signal 903 verifying the status of connection over the network.

In response, the enrollment software 920 on the mobile device forwards, at E4, to the SAME service 940 a request 906 for a list of words that may be used in enrollment. The SAME service 940 generates the list of random words and forwards the generated list of words to the enrollment software 920 over the network 930. The enrollment software 920 on the mobile device displays the word list 909 to the user of the mobile device. For example, the enrollment software 920 displays the list of the generated words on a display screen of the mobile device such that, at E7, the user 900 can read or speak the word list 910 (for example, into a microphone attached to or built into the mobile device). The enrollment software 920 obtains a recording of the user's rendition of the generated words and forwards recorded voice samples, at E8, to the SAME Service 940 over the network 930. The SAME Service 940 processes the recorded voice samples and returns an encrypted voice model specific to the user 900 to the enrollment software 920 for storing in the user's device (e.g., in the mobile device). The SAME Service 940 determines the voice model based on the recorded voice samples, encrypts the voice model using an encryption key that is accessible only by the SAME Service 940 on the network, not by the mobile device, and computes a hash value of the encrypted voice model 912. The computed hash value is then stored 913 in the database 950, which is part of the SAME Service 940. Alternatively, the database 950 may be a separate, distinct database coupled to the SAME Service 940 on the network.

In some embodiments, the SAME Service 940 may process the recorded voice samples by decrypting or recovering the voice samples and computing a voice model from the decrypted voice samples. The computed voice model is encrypted and sent to the mobile device such that the encrypted voice model is stored in memory of the mobile device for later retrieval and use. Further, the SAME Service 940 computes a secure hash value of the encrypted voice model and stores it on the network for later retrieval and use (e.g., integrity checks of received encrypted voice models from users). Alternatively, the encrypted voice model may be stored with an enrollment server for use in later authentication of the user. In some embodiments, the encrypted voice model may be forwarded to a database 950 of the authentication authority (e.g., a database of the financial institution) for storage. In the example, at E9, the SAME Service 940 sends the encrypted voice model 914 to the enrollment software 920 running on the mobile device for local storage. The enrollment is complete 915 once the encrypted voice model is stored in memory of the mobile device. In certain embodiments, the enrollment software 920 may report the completion of the enrollment procedures to the user 900. For example, the enrollment software 920 running on the mobile device may display a message to the user 900 indicating the completion of enrollment, at E10.

FIG. 10 illustrates procedures for an exemplary login process using the SAME service. After completing the enrollment process in the multi-factor biometric based authentication service, the user may wish to access online services provided by a financial institution. As shown in FIG. 10, at L1, the user 1001 uses a mobile device (e.g., a mobile device shown in FIG. 9) to gain access to an enrolled account that the user has with an authority (e.g., a financial institution or bank). The user 1001 uses a login software 1020 running on the mobile device to initiate a login process 1002 and gain access to the user's enrolled account over a network 1025. For example, at L1, the user 1001 uses login software 1020 or banking application programming interfaces (banking APIs) to initiate login 1002 into the user's account with a bank over the network 1025.

At L2, the login software 1020 connects over the network to SAME service 1040. Once a connection is established, the SAME service 1040 queries and obtains an account ID of the user 1004, 1005 from its database 1030. The account information including the account ID and password is verified, the SAME service 1040 sends a status signal 1006 to the login software 1020 verifying the status of the connection 1006, at L3. At L4, the login software 1020 requests a list of words 1007 from the SAME service 1040. Upon receiving the request for the list of words from the login software 1020, the SAME service 1040 generates the list of randomly selected words 906 from its database or predefined lexicon, and forwards the generated word list 1006 to the login software 1020 running on the mobile device, at L5. The login software 1020 displays the generated word list 1009 to the user 1001, at L6, for obtaining voice samples of the user's speech based on the generated word list. The mobile device or login software 1020 prompts the user to read the words of the list that is presented to the user. When prompted, the user 1001 reads the word list 1010, at L7, and the login software 1020 obtains recordings of the rendition of words in the list by the user using the microphone of the mobile device.

At L8, the login software 1020 retrieves an encrypted voice model of the user from its memory and sends the encrypted voice model and recorded voice samples 1011 to the SAME service 1040 over the network. It is noted that before sending the recorded voice samples to the SAME service 1040, the login software 1020 may compress the recorded voice samples and/or encrypt them using the encryption key stored in the mobile device. In the example, the login software 1020 retrieves the encrypted voice model of the user, which is stored in its memory during enrollment of the user, and neither the login software 1020 nor the mobile device keeps a key to decrypt the encrypted voice model of the user. In other embodiments, the encrypted voice model may have been previously stored in a database 1030 during the enrollment process (for example, as discussed with reference to FIG. 9).

As noted earlier, the encrypted voice model retrieved from the memory of the mobile device and the recorded voice samples which are encrypted using the encryption key (i.e., a first encryption key) are forwarded 1011 to the SAME service 1040, at L8. Upon receiving the encrypted data, the SAME service 1040 verifies the recorded voice samples by comparing them against the received voice model of the user. More specifically, the SAME service 1040 computes a hash value of the received voice model and compares the newly computed hash value with a stored hash value of the voice model on the network. If the hash values are identical, then it is determined that the encrypted voice model is not tampered and the voice model is the same voice model as originally created during enrollment. If the hash values are not identical, then the encrypted voice model is determined to be compromised. After a successful comparison of the hash values, the SAME Service 1040 decrypts the voice model using a second encryption key (“a voice model key”). The SAME Service 1040 also decrypts the received encrypted voice samples of the user using the first encryption key used during enrollment (“a voice sample key”). The voice model key is different from the voice sample key and only the SAME Service 1040 has access to the voice model key. The SAME Service 1040 then compares the recovered voice samples with the decrypted voice model of the user. Also, the recovered words in the voice samples are compared to the list of words sent from the SAME Service 1040, at L8.

In the exemplary embodiment, as noted earlier, a hash value of an encrypted voice model for each user is stored in the database 1030 on the network. For comparison against the received recorded voice samples from the user, the SAME Service 1040 retrieves a previously stored hash value of an encrypted voice model of the user from the database 1030 (see 1012 and 1013). The retrieved hash value of the encrypted voice model is compared with newly computed hash value of the received, encrypted voice model from the user during login. If the hash values match, then integrity of the encrypted voice model is confirmed and the received encrypted voice model is decrypted for recovery and use. The recovered voice model is then used to compare with the received voice samples of the user.

In addition to the comparison of the recorded voice samples against the voice model, the user's spoken words are compared against the list of randomly generated words and the Levenshtein Edit Distance is computed to determine how much the two lists differ. The edit distance is converted to a similarity score that indicates how similar the two lists are, as a percentage between 0 and 100. A plurality of confidence scores (e.g., 1-100) is then assigned to the verification results of the recorded voice samples and the comparison result of the spoken words against the word list. Based on the plurality of confidence scores, a composite score (that is averaged over the number of comparison results) is determined and compared against a threshold value (e.g., 95). If the composite score is above or equal to the threshold value, then the SAME Service 1040 determines that the user is authenticated as the same person as originally enrolled in the multi-factor biometric authentication service (e.g., a successful verification result). If the composite score is below the threshold value, the SAME Service 1040 determines that the user cannot be verified as the same person as originally enrolled in the biometric authentication service (e.g., a failed verification result). The verification result is then forwarded 1015 to the login software 1020, at L9. At L10, the login software 1020 displays the verification result 1016 to the user on the mobile device. After the verification, the used voice model by the SAME Service 1040 is discarded so that there is no local copy residing in the SAME Service 1040 or on the network. When the user is positively authenticated, in addition to or in place of displaying of the verification result to the user, the user may be provided access to the online service provided by the bank, without providing an indication of successful verification, which the user is trying to access.

As shown by the above discussion, functions relating to implementing the SAME Service or SAME APIs and various components thereof, i.e., components needed for processing of biometric data for authenticating the user of the mobile device, for enhanced secure business application may be implemented on computers connected for data communication via the components of a packet data network, operating as a server and/or as a biometric authentication server or SAME server as shown in FIG. 2A. Although special purpose devices may be used, such devices also may be implemented using one or more hardware platforms intended to represent a general class of data processing device commonly used to run “server” programming so as to implement the disclosed techniques relating to a system providing the SAME service discussed above, albeit with an appropriate network connection for data communication.

As known in the data processing and communications arts, a general-purpose computer, including a mobile device and an authentication server or the like, typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for implementing the SAME service (i.e., via the SAME APIs) including various components or modules for the SAME service (e.g., voice verification service, word recognition service, face verification service, etc.). The software code is executable by the general-purpose computer that functions as a server and/or that functions as a terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for the disclosed techniques relating to the SAME service, in essentially the manner performed in the implementations discussed and illustrated herein.

FIGS. 11 and 12 provide functional block diagram illustrations of general purpose computer hardware platforms. FIG. 11 illustrates a network or host computer platform, as may typically be used to implement a server. FIG. 12 depicts a computer with user interface elements, as may be used to implement a personal computer or other type of work station or terminal device, although the computer of FIG. 12 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the disclosed techniques relating to the SAME service outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the SAME service into one or more computer platforms that will operate as components of the SAME service in a remote distributed computing environment. Alternatively, the host computer of the SAME service can download and install the presentation component or functionality (including a graphical user interface) into a wireless computing device which is configured to communicate with the SAME server on a network. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the techniques in this disclosure. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the above discussion primarily refers to processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

Many of the above described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions.

In this specification, the term “software” is meant to include firmware residing in read-only memory or applications stored in magnetic storage, which can be read into memory for processing by a processor. Also, in some implementations, multiple software operations can be implemented as sub-parts of a larger program while remaining distinct software operations. In some implementations, multiple software operations can also be implemented as separate programs. Finally, any combination of separate programs that together implement a software invention described herein is within the scope of the invention. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted language, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of steps in the processes disclosed herein is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

The embodiments described hereinabove are further intended to explain and enable others skilled in the art to utilize the invention in such, or other, embodiments and with the various modifications required by the particular applications or uses of the invention. Accordingly, the description is not intended to limit the invention to the form disclosed herein

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the preceding specification, various preferred embodiments have been described with reference to the accompanying drawings. It will, however, be evident that various modifications and changes may be made thereto, and additional embodiments may be implemented, without departing from the broader scope of the claims set forth below. The specification and drawings are accordingly to be regarded in an illustrative rather than restrictive sense.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method comprising steps of:
receiving a first user input for enrolling a user of a mobile device in an authentication service for an online service provided by an entity over a network;
sending over the network to a server enrollment information including a user account;
receiving instructions from the server relating to enrolling the user in the authentication service;
reading a message including a first encryption key for encrypting data communications between the mobile device and the server;
extracting the first encryption key from the message;
receiving a first list of words;
presenting the list of words to the user of the mobile device for acquiring voice samples of the words as spoken by the user;
acquiring the voice samples of the words as spoken by the user; and
encrypting the acquired voice samples of the user using the extracted first encryption key.

2. The method of claim 1, further comprising:
receiving a voice model, wherein the voice model is determined based on the acquired voice samples of the user and is encrypted using a second encryption key by a device on the network, and the second encryption key is not accessible to the mobile device; and
storing the encrypted voice model in memory of the mobile device for authentication purposes.

3. The method of claim 1, wherein the enrollment information further comprises at least one of an identification of the mobile device, account password, personal identification number (PIN), and one or more responses to challenge questions.

4. The method of claim 1, wherein the message includes a Quick Response (QR) code.

5. The method of claim 1, further comprising:
receiving a second user input on the mobile device for using the authentication service;
sending a request for login to the server over the network;
receiving a second list of words;
acquiring voice samples of the second list of words from the user;
sending the acquired voice samples and the encrypted voice model retrieved from the memory of the mobile device for verification of an identity of the user, wherein the acquired voice samples are encrypted using the first encryption key for transmission over the network; and
receiving a result of the verification of the identity of the user.

6. The method of claim 5, wherein the second list of words comprises randomly generated words.

7. The method of claim 5, further comprising, when the identity of the user is verified, allowing the user of the mobile device to access the online service provided by the entity.

8. A system comprising:
a mobile device;
an biometric authentication server for authenticating a user of the mobile device; wherein:
the mobile device is configured to:
receive a first user input for enrolling a user of a mobile device in a biometric based authentication service for a service provided by an entity over a network;
send over the network to the biometric authentication server enrollment information including an identification of the mobile device, user account and associated account password;
receive a message relating to enrolling the user of the mobile device in the biometric authentication service, from the biometric authentication server, wherein the message includes a first encryption key;
extract the first encryption key from the message for encrypting data communications from the mobile device to the biometric authentication server;
receive a first list of words from the network;
present the first list of words to the user of the mobile device for acquiring voice samples of the words spoken by the user;
acquire the voice samples of the words spoken by the user;
encrypt the acquired voice samples using the first encryption key;
send the encrypted voice samples to the biometric authentication server; and
receive an encrypted voice model from the biometric authentication sever, wherein the encrypted voice model is based on the voice samples and encrypted by a second encryption key; and
the biometric authentication server is configured to:
receive from the mobile device enrollment information including the identification of the mobile device, user account and associated account password;
encode the first encryption key in a message to the mobile device;
send the message to the mobile device relating to enrolling the user of the mobile device in the biometric authentication service;
send to the mobile device over the network the first list of words for the user of the mobile device;
receive from the mobile device over the network the acquired voice samples;
generate the voice model of the user based on the received voice samples;
encrypt the voice model of the user using the second encryption key; and
send the encrypted voice model to the mobile device for storage in the memory of the mobile device.

9. The system of claim 8, wherein:
the mobile device is further configured to:
initiate a login process for biometric based authentication;
receive a list of randomly generated words for authentication purposes;
prompt the user of the mobile device to read the randomly generated words;
acquire, as login voice samples of the user, a plurality of recordings of the randomly generated words spoken by the user of the mobile device; and
retrieve the encrypted voice model of the user from the memory of the mobile device;
send the acquired login voice samples and the retrieved encrypted voice model of the user to the biometric authentication server for comparison; and
the biometric authentication server is configured to:
send to the mobile device the list of randomly generated words;
receive from the mobile device over the network the acquired login voice samples and the retrieved encrypted voice model of the user;
compare the acquired login voice samples and the received encrypted voice model of the user received from the mobile device; and
based on the comparison, determine authenticity of the user of the mobile device.

10. The system of claim 9, further comprising a database configured to store information including a device identification of the mobile device, user account information including a user password for login, and a hash value of the voice model.

11. The system of claim 10, wherein communications to and from the mobile device and the biometric authentication server are encrypted using the first encryption key.

12. The system of claim 8, wherein the biometric authentication server is further configured to:
compute a hash value of the voice model during enrollment; and
store the hash value of the voice model for later use.

13. The system of claim 9, wherein the biometric authentication server is further configured to:
determine a second hash value of the received voice model; and
retrieve the hash value of the voice model; and
compare the hash value of the voice model with the second hash value of the received voice model.

14. An apparatus comprising:
a processor;
memory accessible by the processor; and
instructions stored in storage, wherein when executed, the instructions cause the processor to perform functions including functions to:
receive instructions for reading a quick response (QR) code for authentication of a user of the apparatus;
read the QR code, wherein the QR code embeds a first encryption key for encrypting data communications from and to the apparatus;
extracting the first encryption key from the QR code;
receive authentication data including account information relating to a user account of the user;
acquire biometric data from the user of the apparatus;
encrypt the authentication data and the biometric data using the first encryption key;
send the encrypted authentication data and biometric data to a server on a network;
receive encrypted data including a biometric model of the user from the server, wherein the biometric model is computed by the server based on the biometric data collected from the user and is encrypted by a second encryption key, which is not accessible to the apparatus; and
recover the encrypted biometric model from the received encrypted data and store the recovered encrypted biometric model in the memory of the apparatus for use in authentication.

15. The apparatus of claim 14, wherein the biometric data includes voice samples acquired from the user.

16. The apparatus of claim 14, wherein the biometric model is a voice model of the user, wherein the voice model is computed by the server based on a plurality of the voice samples acquired from the user.

17. The apparatus of claim 15, wherein the biometric data include at least one of: fingerprints, iris features, voice samples, facial features, bone structures, gait, and deoxyribonucleic acid (DNA) of the user of the apparatus.

18. The apparatus of claim 15, wherein the authentication data include at least one of: a device identification of the apparatus, user password, personal identification number, and responses to challenge questions by the user.

19. The apparatus of claim 15, wherein the functions further comprise functions to:
receive an indication from the user that the user wishes to access the user account over a network;
collect biometric data from the user of the apparatus;
retrieve the encrypted biometric model of the user from the memory of the apparatus;
send a request for authentication to the server, wherein the request includes encrypted versions of the collected biometric data and the encrypted biometric model of the user; and
receive a result of the authentication of the user from the server.

20. The apparatus of claim 19, wherein the request further include at least one of: a device identification of the apparatus, user password, personal identification number, and responses to challenge questions by the user.
